(19) United States
(12) Patent Application Publication
(10) Pub. No.: US 2018/0121371 A1
(43) Pub. Date: May 3, 2018

(54) READING BY USER-LEVEL PROCESSES

(71) Applicant: Hewlett Packard Enterprise Development LP, Houston, TX (US)

(72) Inventors: Mark Lillibridge, Mountain View, CA (US); Joseph Tucek, Palo Alto, CA (US)

(21) Appl. No.: 15/340,173

(22) Filed: Nov. 1, 2016

(51) Int. Cl. G06F 12/14; G06F 12/06

(52) U.S. Cl. CPC G06F 12/1466; G06F 2212/1016; G06F 2212/1052; G06F 12/0646

(57) ABSTRACT

Examples described herein relate to a memory structure by a user-level process. In an example, a method includes mapping in a read mode, by a kernel, a memory structure and a lock associated with a portion of the memory structure into an address space of a user-level process based on the user-level process being untrusted. The user-level process reads the portion of the memory structure outside of the kernel and determines a state of the lock after the reading of the portion. A write to the portion during the reading of the portion is detected based on the state of the lock.

### BACKGROUND

For security and simplicity, some operating systems are structured hierarchically and isolate higher-level processes from the underlying hardware. Those processes operating on higher levels of the hierarchy may access hardware (such as a processor, memory, storage, I/O, etc.) via an intermediary operating at a lower level of the hierarchy. One example of such an intermediary is an operating system kernel. The kernel may directly interface with the hardware and allow other processes at higher levels, such as the user level, to interface with the hardware by calling (i.e., system calls) an Application Programming Interface (API) of the kernel. The kernel executes the caller's request and returns any results to the higher-level process. In this way, the kernel may hide the complexities of the hardware from the higher-level processes and may prevent a crash of a process from compromising the entire operating system.

### BRIEF DESCRIPTION OF THE DRAWINGS

Certain examples are described in the following detailed description with reference to the drawings, of which:

FIG. 1 is a block diagram of a computing environment according to some examples of the present disclosure.

FIG. 2 is a flow diagram of a method of device access according to some examples of the present disclosure.

FIG. 3 is a block diagram of a computing environment according to some examples of the present disclosure.

FIG. 4 is a memory diagram of a seqlock according to some example of the present disclosure.

FIG. 5 is a memory diagram of a QSX mutex according to some examples of the present disclosure.

FIG. 6 is a flow diagram of a method of directly reading a memory structure by a user-level process according to some examples of the present disclosure.

FIG. 7 is a flow diagram of a method of directly writing a memory structure by a user-level process according to some examples of the present disclosure.

FIGS. 8 and 9 are block diagrams of computing systems including non-transitory computer-readable memory resources according to some examples of the present disclosure.

### DETAILED DESCRIPTION OF SPECIFIC EXAMPLES

An operating system kernel may act as a conduit between higher-level processes and underlying hardware. For example, a user-level process may access (e.g., read, write, etc.) data stored on a set of storage devices by making a system call to the kernel. Upon receiving the system call, the kernel may access the requested data on the storage devices and return any result therefrom to the user-level process.

When a process hands off control to the kernel or another process to access data, the resulting context switch may have an associated delay. As technological improvements reduce the latency of the hardware devices being accessed, the impact of the involving the kernel in the access becomes relatively greater. For example, a hard disk drive seek may have a latency on the order of 10 ms, and flash memory such as a solid-state disk drive may have a latency on the order of 100 μs. However, current and emerging non-volatile memories may have latencies of less than 100 ns. Such low device latencies make any latency associated with the context switch relatively larger. Accordingly, it has been determined that a significant, real world performance improvement may be obtained by reducing the number of system calls and context switches.

The benefit may be realized with any type of access of a storage device. For example, in order to access a segment of data, a computing system may also access various associated metadata. This metadata may include file system metadata used to convert file-level data indicators used by a process to block-level data indicators used by the storage devices. The storage devices themselves may not be aware of the file-to-block relationship but may store the file system metadata that maps the file-level identifiers to the respective block-level identifiers. Accordingly, accessing the data may include multiple accesses of data and metadata. Any of these accesses, whether data or metadata, may be improved by allowing user-level processes to retrieve the data or metadata directly rather than involving the kernel.

The present disclosure provides a system and technique for accessing a memory structure suitable for these applications and others. The memory structure may include metadata, such as file system metadata, data, and/or combinations thereof. In some examples, a kernel maps the memory structure and a set of locks associated with the memory structure into the address space of a user-level process. Mapping the memory structure allows the user-level process to directly access the memory structure without further involving the kernel. To enforce security, the kernel may map the memory structure in a read mode, which allows direct reading but excludes direct writing to the memory structure based on a trust level of the user-level process. This may be appropriate for processes that are trusted to read but not write filesystem data 108, and as used herein, the read mode does not permit direct writing.

In the example, the user-level process reads portions of the memory structure outside of the kernel, thus without involving the kernel or any other process. Because the user-level process may not be the only process accessing the memory structure, after the read, the user-level process may use the locks to determine whether the portions were modified during the read. Thus rather than obtaining a lock, which may entail a system call to the kernel, the user-level process may avoid a context switch latency by detecting a write on its own. If an intervening write occurred, the user-level process may repeat the read. In applications where writes are relatively infrequent, the penalty of repeating a read is outweighed by the reduced latency when direct reads successfully complete without intervening writes.

Many examples in the present disclosure are structured to reduce the number of system calls and context switches while still maintaining data integrity and security. By these mechanisms and others, the present disclosure provides substantial, real world improvements to the operation of a computing system, particularly in the manner in which processes access the storage devices of the system. The technique herein may greatly reduce the latency and overhead involved in accessing these devices.

These examples and others are described with reference to the following figures. Unless noted otherwise, the figures and their accompanying description are non-limiting, and no element is characteristic of any particular example. In that regard, features from one example may be freely incorporated into other examples without departing from the spirit and scope of the disclosure.

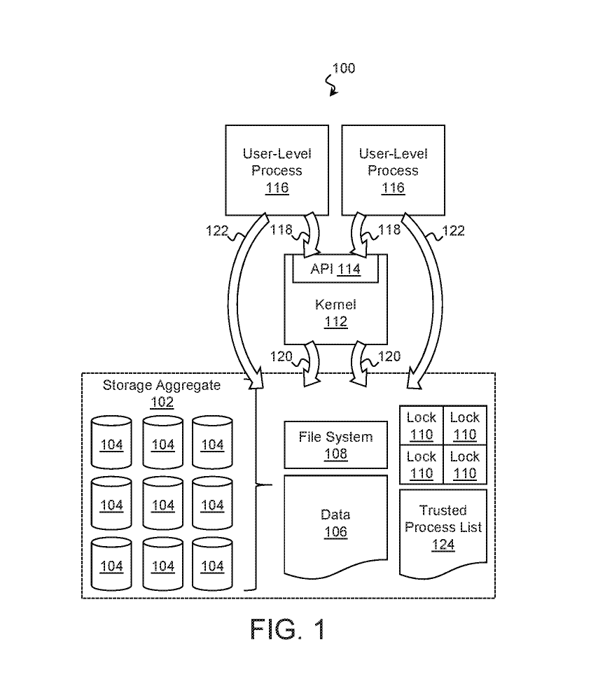

A computing environment for practicing the technique of the present disclosure is described with reference to FIG. 1. In that regard, FIG. 1 is a block diagram of a computing environment 100 according to some examples of the present disclosure. While illustrated as a single unitary entity, the computing environment 100 may represent the processes and resources of any number of computing devices operating together in order to perform a common function. For example, the computing environment 100 may represent a single unitary computing system, a cluster of discrete computing systems, or any permutation thereof.

The computing environment 100 includes a storage aggregate 102 that in turn includes any number, type, and combination of non-transitory storage devices 104. Suitable storage devices 104 include Non-Volatile Memory (NVM), Solid State Drive (SSDs), Hard Disk Drives (HDDs), optical storage devices, tape drives, and/or any other suitable storage devices. The storage devices 104 may store data (e.g., data 106) and metadata used to access the data (e.g., file system 108, locks 110, etc.). The data and metadata may be recorded on the storage devices 104 at discrete block-level addresses and may be accessed via block-level instructions issued to the respective storage device 104. The data and metadata may additionally or alternatively be accessible via byte-level instructions such as loads and stores issued by a processing resource, such as the processing resource 802 of FIG. 8, described in detail below.

The storage devices 104 may be grouped for redundancy and/or performance using Redundant Array of Independent/Inexpensive Disks (RAID) or other suitable groupings, and faster storage devices 104 may operate as caches for larger devices 104. Accordingly, the configuration of the storage devices 104 in the storage aggregate 102 may be complex. In order to keep track of the data and to correlate the various data identifiers, the computing environment 100 may maintain one or more file systems 108 that map virtual or physical block-level data identifiers used by the storage aggregate 102 to file-level data identifiers for use by the processes.

The file system 108 may be maintained, in part, by a kernel 112, a software component that interfaces with one or more hardware components such as the storage devices 104 of the storage aggregate 102. The kernel 112 directly interfaces with the hardware components by providing instructions to the hardware components and receiving responses and interrupts therefrom without any intervening software element. The kernel 112 may include an Application Programming Interface (API) 114 to allow other software components at other hierarchical levels (such as user-level processes 116) to interface with the hardware components.

In an example thereof, the kernel 112 receives a system call involving the storage aggregate 102 from a user-level process 116 at the API 114 as indicated by arrow 118. In the example, the system call contains a request to access (e.g., read, write, etc.) the contents of the storage aggregate 102 such as a file system 108. Because the user-level process 116 may reference data using file-level identifiers, the user-level process 116 may issue system calls to the kernel 112 to access file system metadata used to determine corresponding block-level identifiers. In response, the kernel 112 may query the file system 108, as indicated by arrow 120, to access the requested metadata. The kernel 112 may provide the metadata to the user-level process 116 or may store it for use in future data accesses on behalf of the user-level process 116.

Additionally or in the alternative, the kernel 112 may allow the user-level process 116 to access the contents of the storage devices 104 without any further intervention by the kernel or another process as indicated by arrow 122. Because there is processing overhead associated with the system call to the API 114, allowing the user-level process 116 to access the storage devices 104 directly and thus outside of the kernel 112 may reduce the latency of the operation. To determine which user-level processes 116 will be permitted to access the storage devices 104 directly and, if so, how (e.g., read only or read/write), the kernel 112 may refer to a trusted process list 124 stored upon the storage devices 104. Of course, other ways of determining whether a process may be trusted may be used.

Because multiple user-level processes 116 may attempt to access the data or metadata concurrently, the computing environment 100 may include one or more access control mechanisms. In an example, the storage aggregate 102 stores a set of locks 110 associated with other data and/or metadata. The user-level process 116 and the kernel 112 may use the locks 110 to arbitrate concurrent reads and writes as explained in detail below. In these examples and others, the computing environment 100 provides reduced transactional latency by allowing the user-level process 116 to directly access the storage devices 104, while protecting against access conflicts.

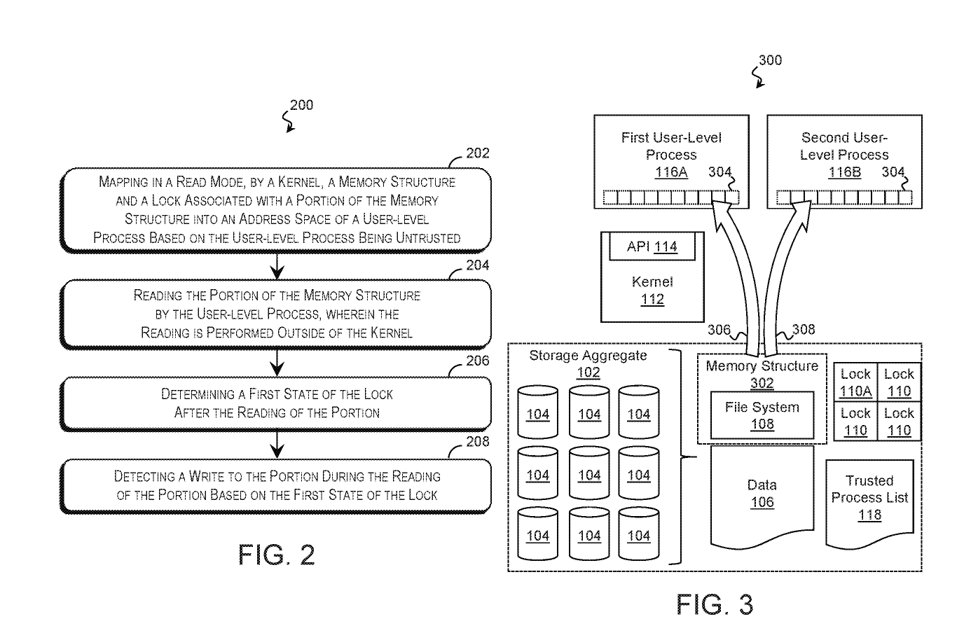

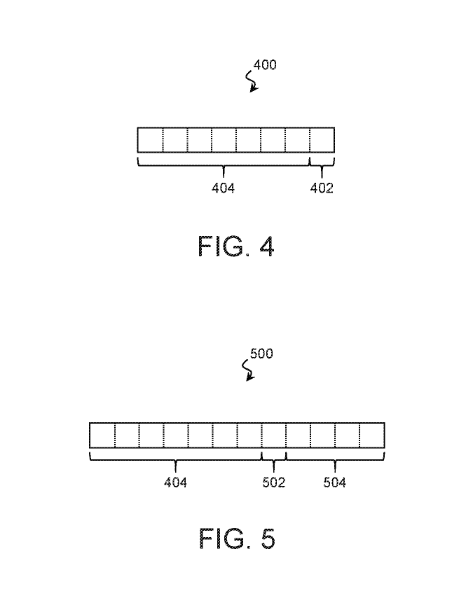

Various examples of a technique for directly accessing devices by user-level processes are described with reference to FIGS. 2-5. FIG. 2 is a flow diagram of a method 200 of device access according to some examples of the present disclosure. The description of method 200 is non-limiting, and steps may be added to and omitted from the method 200 without departing from the disclosure. Furthermore, unless noted otherwise, processes of the method 200 may be performed in any order including being performed concurrently by one or more entities. FIG. 3 is a block diagram of a computing environment 300 according to some examples of the present disclosure. In many aspects, the computing environment 300 may be substantially similar to that of FIG. 1 and may include a storage aggregate, storage devices 104, kernel 112, kernel API 114, data (e.g., data 106), and/or metadata (e.g., file system 108, locks 110, trusted process list 124, etc.) each substantially as described above. Likewise, user-level process 116A and 116B may each be substantially similar to the user-level processes 116 of FIG. 1. FIG. 4 is a memory diagram of a seqlock 400 according to some example of the present disclosure. FIG. 5 is a memory diagram of a QSX mutex 500 according to some examples of the present disclosure. The seqlock 400 and the QSX mutex 500 are each suitable for use in any of the locks 110 of FIG. 3.

Referring first to block 202 of FIG. 2 and to FIG. 3, the kernel 112 maps a memory structure 302 that contains any suitable data and/or metadata, such as the file system 108, and maps a lock 110A associated with at least a portion of the memory structure 302 into an address space 304 of a user-level process 116A, as represented by arrow 306. Mapping the memory structure 302 to the user-level process 116A allows the user-level process 116A to access the memory structure 302 directly without further involving other processes such as the kernel 112.

In mapping the memory structure 302, the kernel 112 may assign access permissions for the user-level process 116A. The kernel may assign any suitable combination of permissions and, in some examples, the kernel 112 determines that the user-level process 116A is trusted for direct reading yet untrusted for direct writing according to the trusted process list 124. In such an example, the kernel 112 may map the memory structure 302 in a read mode such that the user-level process 116A may read the memory structure 302 directly without being permitted to write to it directly. In some examples, despite the memory structure 302 being mapped in a read mode, the user-level process 116A may still write to the memory structure 302 by another mechanism such as using the kernel API 114. The kernel 112 may do fine-grained security checking via that path (e.g., is user process 116A trusted to write to this specific part of the file system?).

Referring to block 204 of FIG. 2, the user-level process 116A reads the portion of the memory structure 302 directly. Because the memory structure has been mapped into the user-level process 116A, the user-level process 116A may read the memory structure 302 directly by accessing the storage devices 104 upon which the memory structure 302 is stored without involving the kernel 112 or another process. In other words, the read is performed outside of the kernel 112. For example, the read may be performed using a load instruction that is part of the user level process 116A. The user-level process 116A may access any of the contents of the storage devices 104 mapped into the address space 304 and in some examples, the user-level process 116A reads a portion of the file system 108. In some such examples, portions of the file system 108 (e.g., directories or block indexes) are structured as binary trees (b-trees), and in reading the file system 108, the user-level process 116A may traverse a binary tree in order to locate a leaf node with metadata that correlates a file-level identifier to a virtual or physical block-level identifier. In some such examples, the portions of the file system 108 are structured as skip lists, and in reading the file system 108, the user-level process 116A may traverse a skip list in order to locate a node with metadata that correlates a file-level identifier to a virtual or physical block-level identifier.

This particular user-level process 116A may not be the only process that accesses the memory structure 302. Accordingly, a set of locks 110 (that includes lock 110A) may be used for access control among the processes. Each lock 110 of the set may correspond to a portion of the memory structure 302, and lock 110A corresponds to the portion of the file system 108 read in block 204. Some examples of suitable locks 110 are described with reference to FIGS. 4 and 5.

FIG. 4 illustrates various examples of a sequential lock (seqlock) 400. The seqlock 400 may include a lock bit 402 associated with a corresponding portion of the memory structure 302. The lock bit 402 may record whether a process has the lock in exclusive mode, and when the lock bit 402 is set, other processes may be prevented from writing the corresponding portion of the memory structure. In particular, the lock bit 402 may be asserted when the portion is being written, for example. The seqlock 400 may also track the number of times the lock has been released from an exclusive mode and, for this purpose, may include a version record 404. If a write is made to the corresponding portion each time the lock is acquired in exclusive mode, then this amounts to a version number for the corresponding portion as each write to the portion may change the version number.

In an example, the version record 404 and the lock bit 402 are grouped together as a number with the lock bit 402 representing the least significant bit(s). When the corresponding portion of the memory structure is to be written, the kernel 112 or other entity atomically attempts to change the lock bit 402 from a zero to a one. If it cannot do this (e.g., the lock bit 402 is already one because some other process already has the lock acquired in exclusive mode), it may try again and again until it succeeds. When the lock bit 402 is set (e.g., when the value of the seqlock 400 is odd), the seqlock 400 prevents other processes from writing to the portion until the seqlock 400 is released. When the write completes, the kernel or other entity increments the seqlock 400, which has the effect of incrementing the version record 404 and resetting the lock bit 402 (e.g., the value of the seqlock 400 becomes even).

The user-level process 116A may read a portion of a memory structure 302 associated with the seqlock 400 using optimistic concurrency control. To do this, the process 116A may first read the seqlock 400 state including the version record 404 and the lock bit 402. If the lock bit 404 is set, then the process 116A concludes a write may be in progress to the portion and it should wait until lock bit 404 is reset. It may do this by spinning until lock bit 404 is reset, rereading the seqlock 400 state each time it loops. Once the lock bit 404 is reset, the user-level process 116A reads the portion of the memory structure 302 and is prepared for the portion to be in an inconsistent state if a write occurs concurrently. After the read, the user-level process 116A reads the seqlock 400 state again and compares it to the state immediately preceding the read of portion of the memory structure 302. If the two seqlock 400 states are the same (i.e., the version record 404 and lock bit 402 values are identical), the user-level process 116A concludes that no write occurred while it was reading the memory structure 302 and thus its read saw good data. Conversely, if the two seqlock 400 states are not the same, a write may have occurred concurrently and the user-level process 116A may have read bad data. In this case, the user-level process 116A it may try reading optimistically again. It will be recognized that reading optimistically using a seqlock 400 only involves reading the seqlock state; it does not necessarily involve writing to the seqlock. Of course, other ways of implementing seqlocks 400 are both contemplated and provided for.

FIG. 5 is an example of a QSX mutual exclusion lock (mutex) 500. Similar to the seqlock 400, the QSX mutex 500 may include an exclusive lock bit 502 that when set prevents other processes from writing to a corresponding portion of the memory structure 302 or holding the lock in shared mode and may include a version record 404 that records the number of times the lock has been released from an exclusive mode. In an example, a writing entity (e.g., the kernel 112 or another entity) atomically attempts to verify that a shared record 504 is zero and set the exclusive lock bit 502 at the beginning of a write to the portion, and when the write concludes, unsets the exclusive lock bit 502 and increments the version number in the version record 404.

The QSX mutex 500 may also provide a shared mode lock where any number of processes may concurrently safely read the portion. To avoid disrupting the reads, the shared mode may prevent writing of the corresponding portion. For this purpose, the QSX mutex 500 may include a shared record 504 that records the number of processes currently holding the lock in the shared mode. A safely-reading entity (as opposed to an entity reading optimistically) may atomically verify that the lock bit 502 is not set and increment the shared record 504 prior to reading the corresponding portion in order to acquire the lock in the shared mode and may decrement the shared record 504 when the reading is complete. When the last safely-reading process has released the lock (e.g., the shared record 504 is zero) the lock is released and may be acquired in exclusive mode for writing. In this way, the QSX mutex 500 provides separate safe-reading and writing lock states.

Like the seqlock, it is also possible to read optimistically (but unsafely) using the QSX mutex 500. The process is similar, but the shared record 504 is not taken into account when determining if the lock state has changed when determining if a write has occurred concurrently. There are thus two ways to read the associated portion using a QSX mutex 500: safely via acquiring the lock in shared mode and unsafely via optimistic concurrency control. The former entails writing to the lock while the latter does not. The former, however, does not involve retrying the read and is less likely to be starved out by writers. Unsafely here refers to the fact that the data read on any given attempt using optimistic concurrency may be bad due to a concurrent write; the reader can detect this, however, so there is no actual danger of returning bad data to higher levels of the process.

Returning to FIG. 3, the user-level process 116A may read the portion of the memory structure 302 by making a system call to the kernel 112 to modify the corresponding lock 110A (e.g., to acquire the corresponding lock in shared mode). However, as an alternative to acquiring the lock, the user-level process 116A may read the lock 110A without acquiring it and detect from the lock 110A value(s) whether another entity (e.g., user-level process 116B) has modified the memory structure 302 while it was being read. In some examples, the intervening modification can be detected from observation(s) of the state of the lock 110A, thereby avoiding the system call to the kernel 112 and an associated delay.

Referring back to FIG. 2 and to block 206 thereof, in some such examples, the user-level process 116A directly reads the lock 110A associated with the portion of the memory structure 302 read in block 204 to determine a state of the lock 110A after reading the portion. This may include determining a state of a QSX mutex 500 similar to that of FIG. 4 and/or a seqlock 400 similar to that of FIG. 5. Referring to block 208, the user-level process 116A uses the state of the lock 110A to detect whether an intervening write occurred to the portion of the memory structure 302 while it was being read.

In this way, the user-level process 116A may determine whether the read may have been interrupted by an intervening write. While the user-level process 116A may also acquire a lock 110A for the memory structure 302 prior to the read to prevent the intervening write, acquiring a lock may entail a write to the lock 110A itself. If the lock 110A is mapped in a read mode, such a write may entail a system call to the kernel 112 and a context switch. However, latency associated with a system call may be avoided by reading the portion first and detecting the intervening write based on the lock 110A as described in blocks 206 and 208. Particularly in applications where reads are frequent and writes are infrequent, the penalty of an interrupted read is outweighed by the advantage of omitting the acquiring of the lock.

In these examples and others, the technique provides a mechanism for the user-level process 116A to directly access the memory structure 302. In some such examples, the user-level process 116A may do so without involving the kernel 112 or any other process once the kernel 112 maps the memory structure 302 to the user-level process 116A. In some such examples, the user-level process 116A is able to read the memory structure 302 without modifying locks 110 and without interrupting writes from other processes.

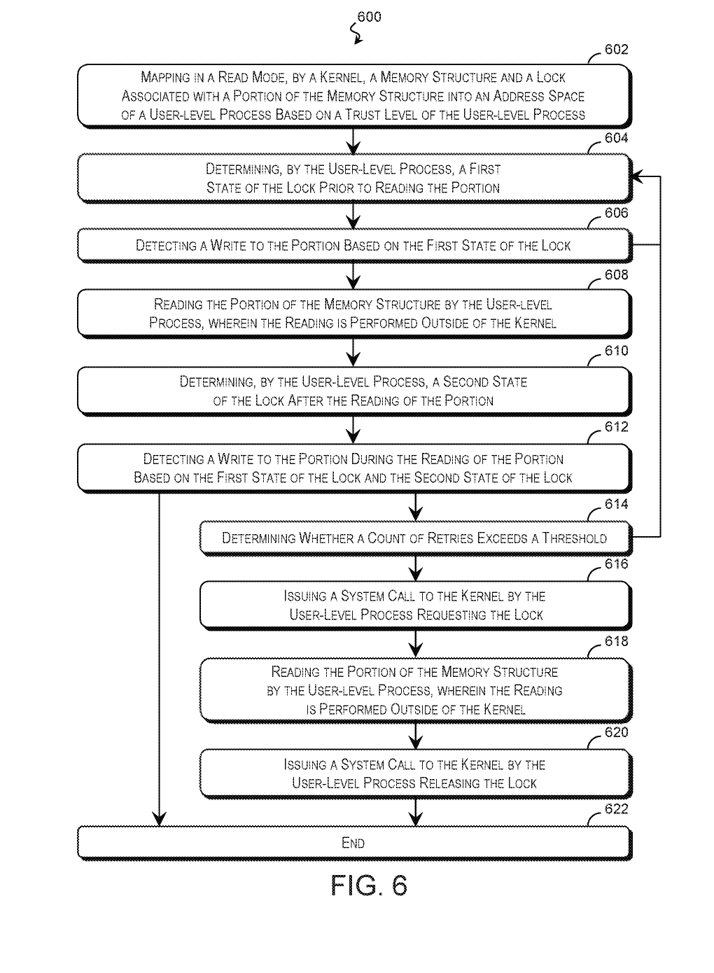

Further examples of the technique for directly accessing devices by user-level processes are described with reference to FIG. 6. FIG. 6 is a flow diagram of a method 600 of directly reading a memory structure by a user-level process according to some examples of the present disclosure. The description of method 600 is non-limiting, and steps may be added to and omitted from the method 600 without departing from the disclosure. Furthermore, unless noted otherwise, processes of the method 600 may be performed in any order including being performed concurrently by one or more entities.

Referring to block 602 of FIG. 6 and referring still to FIG. 3, a kernel 112 maps a memory structure 302 and a set of locks 110 (including lock 110A) into an address space 304 of a user-level process 116A substantially as described in block 202 of FIG. 2. The memory structure 302 and locks 110 may be mapped in a read mode based on a trust level associated with the user-level process 116A.

Referring to block 604, prior to reading a portion of the memory structure 302 (such as a portion of a file system 108 contained in the memory structure 302), the user-level process 116A may determine a first state of a lock 110A associated with the portion of the memory structure 302. The user-level process 116A may directly read the lock 110A to determine the first state without involving the kernel or another process. The lock 110A may take any suitable form, and in some examples, the lock 110A includes a seqlock 400 substantially similar to that of FIG. 4 and/or a QSX mutex 500 substantially similar to that of FIG. 5. Accordingly, the first state of the lock 110A may include the version number recorded in the version record 404 thereof.

The first state of the lock 110A may indicate that the portion of the memory structure 302 is currently being written (based on a lock bit 402, an exclusive lock bit 502, and/or other element of the lock 110). If the user-level process 116A determines in block 606 that the portion is currently being written, the method returns to block 604 after a delay. If the user-level process 116A determines in block 606 that the portion is not currently being written, the method proceeds to block 608.

Referring to block 608, after determining the first state of the lock 110A, the user level-process reads the portion of the memory structure 302 substantially as described in block 204 of FIG. 2. As the portion of the memory structure 302 has been mapped into the address space of the user-level process 116A, the user-level process 116A may read the portion directly from the storage devices 104 without involving the kernel 112 or another process. In some examples, the user-level process 116A directly reads a portion of a file system 108 of the memory structure 302 to determine a virtual or physical block-level data identifier associated with a file-level data identifier.

Referring to block 610, the user-level process 116A determines a second state of the lock 110A after the reading performed in block 608. The user-level process 116A may directly read the lock 110A to determine the second state without involving the kernel or another process. This may be performed substantially as described in block 206 of FIG. 2 and/or block 604 of FIG. 6, and in some examples, the second state of the lock 110A includes a version number recorded in the version record 404 of a seqlock 400 or a QSX mutex 500.

Referring to block 612, the user-level process 116A determines from the first state and/or the second state of the lock 110A whether a write occurred during the reading of block 608. This may be performed substantially as described in block 208 of FIG. 2. For example, the user-level process 116A may determine that a write occurred because a version number of the first state is different from a version number of the second state. In another example, the user-level process may determine that a write occurred because the second state indicates that a lock bit 402 or an exclusive lock bit 502 of the lock 110A was set at the time the read of block 608 completed.

If it is determined that an intervening write occurred, the method 600 continues to block 614 where the user-level process 116A determines how many times the read has been retried due to intervening writes and whether the number of retries exceeds a threshold. If the number of retries does not exceed the threshold, the method may return to block 604 after a delay.

In many applications, reads will greatly outnumber writes, and retries due to an intervening write will be infrequent. However, in the event that the number of retries exceeds a threshold, the user-level process 116A may request a lock for the portion of the memory structure 302 via the kernel 112. In some such examples, the method 600 proceeds from block 614 to block 616 where the user-level process 116A issues a system call to the kernel 112 via an API 114 requesting the lock in order to read the portion of the memory structure 302. When the lock is issued, the user-level process directly reads the portion in block 618 substantially as described in block 608 of FIG. 6 and issues a system call to the kernel API 114 to release the lock in block 620. In alternative variant, steps 606, 618, and 620 are replaced by a system call to the kernel 112 that has the kernel 112 itself read the data and return it to user space. This may be slower than the process directly reading the portion of the memory structure because an extra copy is performed. The method 600 concludes in block 622.

Likewise, if the comparison of block 612 determines that an intervening write did not occur during the read of block 608, the method 600 proceeds from block 612 to block 622 where the method 600 concludes.

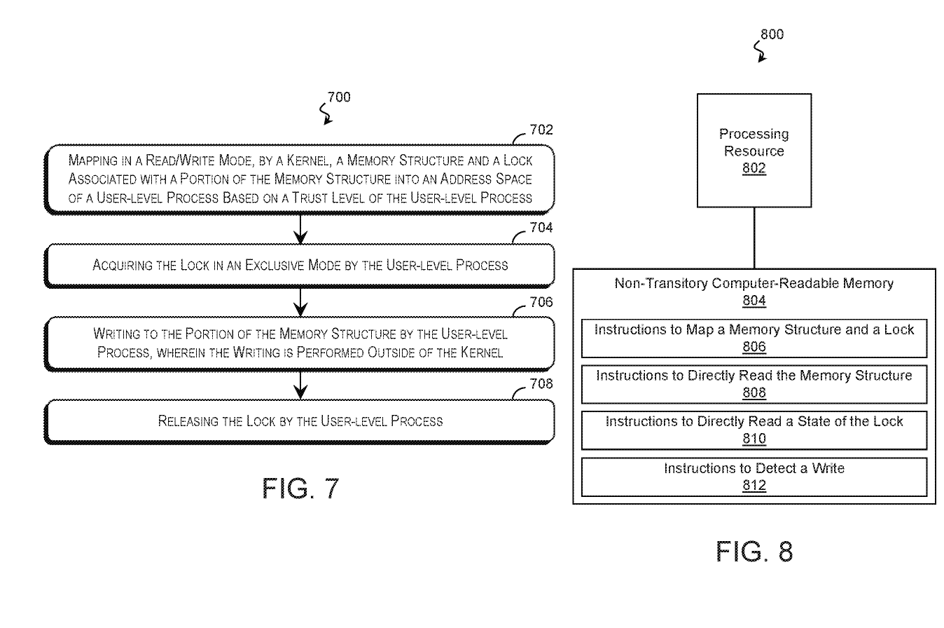

Method 200 and method 600 allow a first user-level process 116A to directly read a portion of a memory structure 302, while detecting writes performed by other processes such as a second user-level process 116B. A method for writing to the memory structure 302 by the second user-level process 116B is described with reference to FIG. 7. In that regard, FIG. 7 is a flow diagram of a method 700 of directly writing a memory structure by a user-level process according to some examples of the present disclosure. The description of method 700 is non-limiting, and steps may be added to and omitted from the method 700 without departing from the disclosure. Furthermore, unless noted otherwise, processes of the method 700 may be performed in any order including being performed concurrently by one or more entities. In various examples, the processes of method 700 are performed concurrently with the processes of method 200 and/or method 600.

Referring first to block 702 of FIG. 7 and to FIG. 3, the kernel 112 maps a memory structure 302 that contains any suitable data and/or metadata, such as a file system 108, and maps a lock 110A associated with at least a portion of the memory structure 302 into an address space 304 of a second user-level process 116B as indicated by arrow 308. The kernel may assign any suitable combination of permissions and, in some examples, the kernel 112 determines that the second user-level process 116B is trusted for direct reading as well as direct writing according to a trusted process list 124. In such an example, the kernel 112 may map the memory structure 302 in a read/write mode such that the second user-level process 116B may read or write to the memory structure 302 and the lock 110A directly without further intervention by the kernel 112 or another entity.

Referring to block 704, the second user-level process 116B acquires the lock 110A in an exclusive mode for writing to the portion of the memory structure 302. In some examples, the lock 110A includes a seqlock 400, and acquiring the lock 110A in an exclusive mode includes setting a lock bit 402 thereof. In some examples, the lock 110A includes a QSX mutex 500 and acquiring the lock 110A includes verifying from the shared record 504 and the exclusive lock bit 502 that no other process has acquired the lock in a shared mode or an exclusive mode and setting the exclusive lock bit 502. Because the lock 110A has been mapped into the address space of the second user-level process 116B using a read/write mode, the second user-level process 116B may acquire the lock by writing to it directly (possibly using a test and set instruction or atomic compare and swap instruction) without intervention by the kernel 112 or another entity.

Referring to block 706, the second user-level process 116B directly writes to the portion of the memory structure 302 associated with the lock 110A. Because the memory structure 302 has been mapped into the address space of the second user-level process 116B read/write, the second user-level process 116B may write the memory structure 302 directly without intervention by the kernel 112 or another entity. Referring to block 708, the second user-level process releases the lock 110A.

The processes of methods 200, 600, and/or 700 may be performed by any combination of hard-coded and programmable logic. In some examples, a processing resource utilizes instructions stored on a non-transitory computer-readable memory resource to perform at least some of these processes. Accordingly, examples of the present disclosure may take the form of a non-transitory computer-readable memory resource storing instructions that perform at least part of methods 200, 600, and/or 700. FIG. 8 is a block diagram of a computing system 800 including a non-transitory computer-readable memory resource according to some examples of the present disclosure.

The computing system 800 may include one or more processing resources 802 operable to perform any combination of the functions described above. The illustrated processing resource 802 may include any number and combination of Central Processing Units (CPUs), Graphics Processing Units (GPUs), microcontrollers, Application-Specific Integrated Circuits (ASICs), Field-Programmable Gate Arrays (FPGAs), and/or other processing resources.

To control the processing resource 802, the computing system 800 may include a non-transitory computer-readable memory resource 804 that is operable to store instructions for execution by the processing resource 802. The non-transitory computer-readable memory resource 804 may include any number of non-transitory memory devices including battery-backed RAM, SSDs, HDDs, optical media, and/or other memory devices suitable for storing instructions. The non-transitory computer-readable memory resource 804 may store instructions that cause the processing resource 802 to perform any process of any block of methods 200, 600, and/or 700, examples of which follow.

Referring to block 806, the non-transitory computer-readable memory resource 804 may store instructions that cause the processing resource 802 to map a memory structure 302 and a lock 110A associated with a portion of the memory structure 302 into an address space 304 of a user-level process 116A. The memory structure 302 and the lock 110A may be mapped in a read mode based on a trust level of the user-level process 116A. This may be performed substantially as described in block 202 of FIG. 2 and/or block 602 of FIG. 6.

Referring to block 808, the non-transitory computer-readable memory resource 804 may store instructions that cause the processing resource 802 to directly read the portion of the memory structure 302 by the user-level process 116A. This may be performed substantially as described in block 204 of FIG. 2 and/or block 608 of FIG. 6.

Referring to block 810, the non-transitory computer-readable memory resource 804 may store instructions that cause the processing resource 802 to directly read a first state of the lock 110A by the user-level process 116A after the portion is read. This may be performed substantially as described in block 206 of FIG. 2 and/or block 610 of FIG. 6.

Referring to block 812, the non-transitory computer-readable memory resource 804 may store instructions that cause the processing resource 802 to detect a write to the portion during the read of the portion based on the first state of the lock 110A. This may be performed substantially as described in block 208 of FIG. 2 and/or block 612 of FIG. 6.

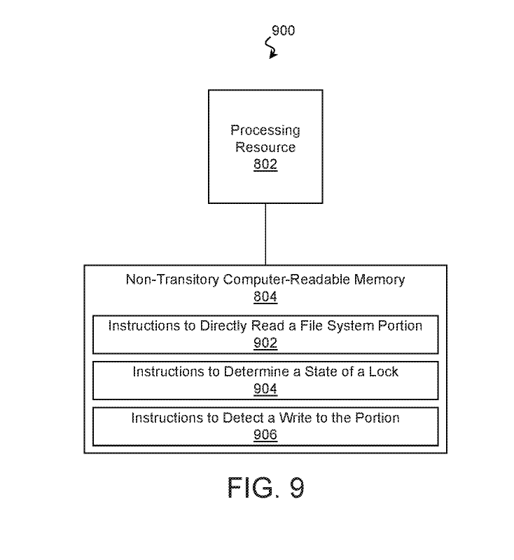

Further examples are described with reference to FIG. 9, which is a block diagram of a computing system 900 including a non-transitory computer-readable memory resource according to some examples of the present disclosure. The computing system 900 may include one or more processing resources 802 and a non-transitory computer-readable memory resource 804 that is operable to store instructions for execution by the processing resource 802 each substantially as described above. The non-transitory computer-readable memory resource 804 may store instructions that cause the processing resource 802 to perform any process of any block of methods 200, 600, and/or 700, examples of which follow.

Referring to block 902, the non-transitory computer-readable memory resource 804 may store instructions that cause the processing resource 802 to directly read, by a user-level process 116A, a portion of a file system 108 that is mapped into an address space 304 of the user-level process 116A. The file system 108 may be mapped in a read mode based on a trust level of the user-level process 116A. This may be performed substantially as described in block 204 of FIG. 2 and/or block 608 of FIG. 6.

Referring to block 904, the non-transitory computer-readable memory resource 804 may store instructions that cause the processing resource 802 to determine a first state of a lock 110A associated with the portion of the file system 108 after the read of the portion file system 108 by the user-level process 116A. This may be performed substantially as described in block 206 of FIG. 2 and/or block 610 of FIG. 6.

Referring to block 906, the non-transitory computer-readable memory resource 804 may store instructions that cause the processing resource 802 to detect a write of the portion of the file system 108 during the read of the portion based on the determined first state of the lock 110A. This may be performed substantially as described in block 208 of FIG. 2 and/or block 612 of FIG. 6.

In the foregoing description, numerous details are set forth to provide an understanding of the subject disclosed herein. However, implementations may be practiced without some or all of these details. Other implementations may include modifications and variations from the details discussed above. It is intended that the appended claims cover such modifications and variations.

What is claimed is:

1. A method comprising:
mapping in a read mode, by a kernel, a memory structure and a lock associated with a portion of the memory structure into an address space of a user-level process based on the user-level process being untrusted;
reading the portion of the memory structure by the user-level process, wherein the reading is performed outside of the kernel;
determining a first state of the lock after the reading of the portion; and
detecting a write to the portion during the reading of the portion based on the first state of the lock.

2. The method of claim 1, wherein the portion of the memory structure includes file system metadata mapping a file-level data indicator to a block-level data indicator.

3. The method of claim 1 comprising determining a second state of the lock prior to the reading of the portion, wherein the detecting of the write is based on the first state of the lock and the second state of the lock, and wherein the determining of the first state of the lock and the determining of the second state of the lock are performed by the user-level process outside of the kernel.

4. The method of claim 3,
wherein the first state of the lock includes a first version number,
wherein the second state of the lock includes a second version number, and
wherein the detecting of the write is based on the first version number being different from the second version number.

5. The method of claim 1,
wherein the user-level process is a first user-level process, the method comprising:
mapping in a read/write mode, by the kernel, the memory structure and the lock into an address space of a second user-level process based on the second user-level process being trusted, and
acquiring the lock in an exclusive mode by the second user-level process, wherein the write is performed by the second user-level process.

6. The method of claim 5, wherein the write and the acquiring of the lock are performed by the second user-level process outside of the kernel.

7. The method of claim 1 comprising rereading the portion of the memory structure by the user-level process based on the detecting of the write.

8. The method of claim 7 comprising:
tracking a number of rereads of the portion;
requesting from the kernel, by the user-level process, a lock permission for the portion of the memory structure based on the number of rereads of the portion exceeding a threshold.

9. The method of claim 1, wherein the lock is selected from the group consisting of: a seqlock and a mutex.

10. A non-transitory computer-readable memory resource storing instructions that when executed cause a processing resource to:
map, in a read mode, a memory structure and a lock associated with a portion of the memory structure into an address space of a user-level process based on a trust level of the user-level process;
directly read the portion of the memory structure by the user-level process;
directly read a first state of the lock by the user-level process after the portion is read; and
detect a write to the portion during the read of the portion based on the first state of the lock.

11. The non-transitory computer-readable memory resource of claim 10, wherein the portion of the memory structure includes a file system metadata that maps a file-level data indicator to a block-level data indicator.

12. The non-transitory computer-readable memory resource of claim 10 storing instructions that when executed cause the processing resource to:
directly read a second state of the lock before the portion is read; and
detect the write to the portion during the read of the portion based on a difference between the first state of the lock and the second state of the lock.

13. The non-transitory computer-readable memory resource of claim 12 storing instructions that when executed cause the processing resource to:
detect the write to the portion during the read of the portion based on a difference between a version number of the first state of the lock and a version number of the second state of the lock.

14. The non-transitory computer-readable memory resource of claim 10, wherein the user-level process is a first user-level process, the memory resource storing instructions that when executed cause the processing resource to:
map, in a read/write mode, the memory structure and the lock into an address space of a second user-level process based on a trust level of the second user-level process; and
acquire the lock in an exclusive mode by the second user-level process, wherein the write is performed by the second user-level process.

15. The non-transitory computer-readable memory resource of claim 10 storing instructions that when executed cause the processing resource to:
reread the portion of the memory structure by the user-level process based on the write.

16. The non-transitory computer-readable memory resource of claim 15 storing instructions that when executed cause the processing resource to:
track a number of rereads of the portion;
request from a kernel, by the user-level process, a lock permission for the portion of the memory structure based on the number of rereads of the portion exceeding a threshold.

17. The non-transitory computer-readable memory resource of claim 10, wherein the lock is selected from the group consisting of: a seqlock and a mutex.

18. A non-transitory computer-readable memory resource storing instructions that when executed cause a processing resource to:
directly read, by a user-level process, a portion of a file system that is mapped into an address space of the user-level process, wherein the file system is mapped in a read mode based on a trust level of the user-level process;
determine a first state of a lock associated with the portion of the file system after the read of the portion file system by the user-level process; and
detect a write of the portion of the file system during the read of the portion based on the determined first state of the lock.

19. The non-transitory computer readable memory resource of claim 18 storing instructions that cause the processing resource to:
determine a second state of the lock before the read of the file system by the user-level process; and
detect the write based on a difference between the first state of the lock and the second state of the lock.

20. The non-transitory computer readable memory resource of claim 19,
wherein the first state of the lock includes a first version number,
wherein the second state of the lock includes a second version number, and
wherein the non-transitory computer readable memory resource stores instructions that cause the processing resource to detect the write based on a difference between the first version number and the second version number.
